(19) United States
(12) Patent Application Publication
(10) Pub. No.: US 2008/0265540 A1
(43) Pub. Date: Oct. 30, 2008

(54) Guiding Element for a Track Element in a Wheel Suspension of a Vehicle

(76) Inventors: Christoph Elbers, Dielingen (DE); Metin Ersoy, Walluf (DE); Gunter Godert, Trier (DE); Peter Hofmann, Gauting (DE); Manuel Lower, Velbert (DE); Hubert Siemer, Dinklage (DE); Alfred Stenzenberger, Funfstetten (DE)

Correspondence Address: MCGLEW & TUTTLE, PC, P.O. BOX 9227, SCARBOROUGH STATION, SCARBOROUGH, NY, 10510-9227, US

(21) Appl. No.: 12/089,224

(22) PCT Filed: Oct. 5, 2006
(86) PCT No.: PCT/DE06/01743

§ 371 Date: Apr. 4, 2008

(30) Foreign Application Priority Data
Oct. 5, 2005 (DE) 10 2005 047 868.9

(51) Int. Cl. B60G 25/00

(52) U.S. Cl. 280/124.1

(57) ABSTRACT

A guide element for a guideway element in a wheel suspension of a vehicle has one of the elements arranged such that it is connected essentially rigidly to the body and the other element arranged such that it is connected essentially rigidly to the wheel and a plain bearing, which makes possible a displacing motion of the guide element on the guideway element, is formed between these elements. The guide element is guided in a rotatingly movable and/or pivotingly movable manner on the guideway element via a joint arrangement, within which the plain bearing ring is arranged, which is guided with its circular passage opening, adapted to the cross section of the guideway element, on the guideway element. This joint arrangement may be designed as a rubber bushing or as a ball and socket joint. A plurality of sliding rings may be arranged in a so-called ball layer hollow body one on top of another and at least with a section facing the guideway element essentially at right angles to the longitudinal axis of the guideway element in a slightly displaceable manner. A guideway extending in a curved shape can thus be embodied. The sliding ring may have an elastomer ring, to which a metal bushing is vulcanized on the outside and to which a plastic sliding ring, which is in contact by its inside with the guideway element, is vulcanized on the inside.

### CROSS REFERENCE TO RELATED APPLICATIONS

This application is a United States National Phase application of International Application PCT/DE2006/001743 and claims the benefit of priority under 35 U.S.C. § 119 of German Patent Application DE 10 2005 047 868.9 filed Oct. 5, 2005, the entire contents of which are incorporated herein by reference.

### FIELD OF THE INVENTION

The present invention pertains to a guide element for a track (guideway) element in a wheel suspension of a vehicle, wherein one of the elements is arranged essentially as an element that is rigidly connected to the body and the other element is arranged essentially as an element that is rigidly connected to the wheel, and a plain bearing, which makes possible a displacing motion of the guide element on the guideway element, is formed between these elements. Especially German Patent Application No. DE 10 2004 048 789, which was not published before, is to be mentioned as a state of the art.

### BACKGROUND OF THE INVENTION

Conventional wheel suspensions meet the kinematic and elastokinematic requirements imposed on the guiding of the vehicle wheel with kinematic chains of control arms and joints, which guide the wheel carrier and hence the wheel in relation to the vehicle body. For example, the double wishbone principle and its variants, such as space rod or five-link axles, have become generally accepted for high requirements on vehicle dynamics and driving smoothness. Wheel guides with physically embodied, so-called guideway elements, along which guide elements are displaceable, represent another known state of the art. For example, the old German Patent Specification No. DE 613 775 shows a steerable rigid axle with a wheel guide in the vertical direction, which is formed by a linear, essentially vertically directed guide tube, which is rigidly connected to the wheel carrier, and within which a spindle supported on the rigid axle is guided longitudinally displaceably. An individual wheel suspension of a similar design is shown in U.S. Pat. No. 2,992,013.

Unpublished German Patent Application No. DE 10 2004 048 789 discloses a guide element for a track (guideway) element in a wheel suspension of a vehicle. A vehicle guide with physically embodied guideway elements, on which so-called guide elements are arranged longitudinally displaceably, is perfected in this German Patent Application No. DE 10 2004 048 789. Unlike in the relatively old state of the art mentioned, guideway elements extending in a three-dimensionally curved manner are shown herein, in particular. Guide elements mounted on roller bearings are displaceable on or along these, the guideway element being preferably fastened to the body or body shell of the vehicle, while the corresponding guide element is associated with the respective wheel of the vehicle and is therefore fastened to a wheel carrier or the like. (It shall be pointed out that the reversed assignment is also possible.) Furthermore, the possibility of using a plain bearing between the guide element and the guideway element is pointed out in this patent application.

### SUMMARY OF THE INVENTION

It is an object of the invention to provide a plain bearing of a favorable design for such a unit comprising a guide element and a guideway element in a vehicle wheel suspension.

The accomplishment of this object is provided via a joint arrangement, within which at least one plain bearing ring is arranged, which ring is guided with its passage opening on the guideway element, the guide element is guided on the guideway element in a rotatingly movable and/or pivotingly movable manner. According to preferred embodiments, the joint arrangement is designed in the form of a rubber bushing or in the form of a ball and socket joint.

A guideway, which extends in a curved shape with a radius that is not constant in space, or a corresponding guideway element with different curvatures at different points, is necessary to create a wheel guide that is favorable in respect to the vehicle dynamics. However, a simple, conventional plain bearing solution cannot be used for such a bent guideway. A combination of a suitable joint for ensuring an angular motion that is necessary from the curved guideway and at least one plain bearing element, which is arranged in this joint or in a corresponding, so-called joint arrangement, is therefore proposed. The plain bearing element provided according to the invention is at least a so-called plain bearing ring, which is mounted in a hollow body of the joint arrangement.

Thus, an at least slight rotary motion and/or pivoting motion of the guide element in relation to the guideway element, which must be carried out when the guide element is displaced on a guideway element, which usually has a non-constant curvature, in the direction of the longitudinal axis of the guideway element, is possible with the joint arrangement. A pivoting motion is defined herein as the pivoting of the guide element about an axis, which is at right angles to the axis of the guideway element at the instantaneously relevant point, at which the guide element is located relative to the guideway element, while a rotary motion is a rotation of the guide element about the instantaneously relevant axis segment of the guideway element.

The joint arrangement provided according to the invention makes possible these motions and may be preferably designed for this in the form of an elastomeric rubber bushing or in the form of a ball and socket joint. In the case of a so-called “elastomer joint” (“rubber bushing”), an inner sleeve and, concentrically thereto, an outer sleeve may be provided, between which an elastomer layer, which establishes the required flexibility, is provided. The plain bearing ring(s) can then be provided within the inner sleeve. By contrast, the plain bearing ring(s) may be provided in case of a ball and socket joint within a so-called ball layer hollow body. A ball layer is generally defined as a body derived from a ball, which is formed by cutting off two ball segments located opposite each other. The so-called ball layer hollow body is then mounted rotatably in a ball shell provided in the guide element or in a housing or in a sleeve of a housing in order to form a ball and socket joint. The at least one plain bearing ring, which is arranged in the ball layer hollow body, is guided displaceably on the guideway element and thus guides the ball layer hollow body and thus also the housing or the sleeve of the guide element on the guideway element.

Comparable statements can also be made in the first case of the “elastomer joint” concerning the inner sleeve and the outer sleeve. The joint arrangement may also comprise a combination of a ball and socket joint and an elastomer joint, for example, in such a way that the outer sleeve of the elastomer joint or of the rubber bushing, which outer sleeve was mentioned farther above, is arranged in a ball layer hollow body or is designed as such, so that the elastomer joint is mounted practically in a ball and socket joint.

The guideway element preferably has a circular cross section, so that the passage opening in the plain bearing ring, adapted hereto, is likewise circular, which enables this [ring], especially in the course of a displacement along the guideway element, to be additionally rotated about the longitudinal axis of the guideway element. The plain bearing ring should have a certain minimum thickness or height (when viewed in the direction of the longitudinal axis of the guideway element) for reasons of strength. To make thus possible the most exact guiding possible of the plain bearing ring by the guideway element despite the curved sections of the guideway element, a slight relative motion should be possible between the inner section of a plain bearing ring, which section faces the guideway element, and the outer section thereof, which faces the ball layer hollow body or the inner sleeve of the so-called rubber bushing (=elastomer joint). In a preferred embodiment, the plain bearing ring itself may have for this purpose an elastomer ring, to which a metal bushing is vulcanized on the outside and to which a plastic sliding ring, which is in contact by its inside with the guideway element, is vulcanized on the inside. Both the outer metal bushing and the inner plastic sliding ring are preferably rigidly connected to the elastomer ring, preferably by vulcanization. The elastomer layer of the elastomer ring is used here to transmit the forces from the plastic sliding ring to the metal bushing and to compensate the component tolerances, and it makes possible the slight displaceability of the inner section of the plain bearing ring in relation to the outer section thereof, which was already referred to above, and it thus makes it possible to form a guideway with variable radius.

The forces that are to be transmitted between the guide element and the guideway element may be relatively strong, and the plain bearing ring should therefore be relatively thick or high for reasons of strength. This once again makes difficult an exact guiding because of the curved sections despite the elastomer material provided, and it is therefore additionally proposed that a plurality of plain bearing rings, arranged one on top of another, be provided, whose respective inside sections, facing the guideway element, are, in turn, slightly displaceable in relation to one another because of the respective elastomer rings, namely, in directions at right angles to the longitudinal axis of the guideway element. These several plain bearing rings, which are provided to bring about the necessary angular motion, are then fixed and mounted quasi as a package with their outsides, i.e., with their section facing the guideway element, in the ball layer hollow body or in the inner sleeve of the rubber bushing or of the elastomer joint. Due to the plurality of plain bearing rings, it becomes possible to obtain a modular system, which provides a number of plain bearing rings that is correspondingly necessary as a function of the force to be transmitted, and it shall be pointed out (once again) that the elastomer rings stacked one on top of another do not need to be fastened on the outside in an independent metal bushing or the like, but this metal bushing surrounding the elastomer ring on the outside may be formed by the inner sleeve of the elastomer joint or the rubber bushing or by the ball layer hollow body itself.

The cross section of the plastic sliding ring is preferably to be shaped such that optimal transmission of the forces via the elastomer ring to the outer metal bush is achieved, and the value of the force that can be transmitted also depends on the materials used. In view to the best possible contact between the plastic sliding ring and the guideway of the guideway element in all possible operating states, the inside of the plastic sliding ring is preferably rounded, i.e., it is provided with a radius.

Finally, it is proposed that the entire unit, formed by the guide element and the guideway element, be sealed by means of one or preferably two bellows or the like for protection against dust, dirt and moisture. At least one bellows or the like, which extends essentially along the guideway element and by which the space between the guide element and the guideway element is covered against contamination over the entire possible path of motion of the guide element on the guideway element, may be arranged for this at the guide element. The bellows is preferably of a split design and is fastened with a part provided above the guide element and with a part provided under the guide element to the guide element or to the housing thereof.

The present invention will be explained in more detail below on the basis of preferred exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a section through a guide element according to the present invention with a ball and socket joint as well as with a section of the guideway element belonging to it in an abstract form;

FIG. 1a is detail X from FIG. 1 in a slightly enlarged form;

FIG. 2 is a three-dimensional half-section of a corresponding plain bearing ring;

FIG. 3 is a section of a ball layer hollow body forming a part of the ball and socket joint and showing a plurality of plain bearing rings;

FIG. 4 is a sectional three-dimensional view showing a plurality of plain bearing rings in a section of a rubber bushing, which forms a so-called “elastomer joint” as an alternative to the ball and socket joint;

FIG. 5a is a sectional three-dimensional view showing another variant, in which a ball and socket joint and an elastomer joint are combined;

FIG. 5b is an individual plain bearing ring of the variant of FIG. 5a (without an outside metal bushing); and

FIG. 6 is a sectional three-dimensional outside view of the unit comprising a guide element and the guideway element according to the present invention.

### DESCRIPTION OF THE PREFERRED EMBODIMENTS

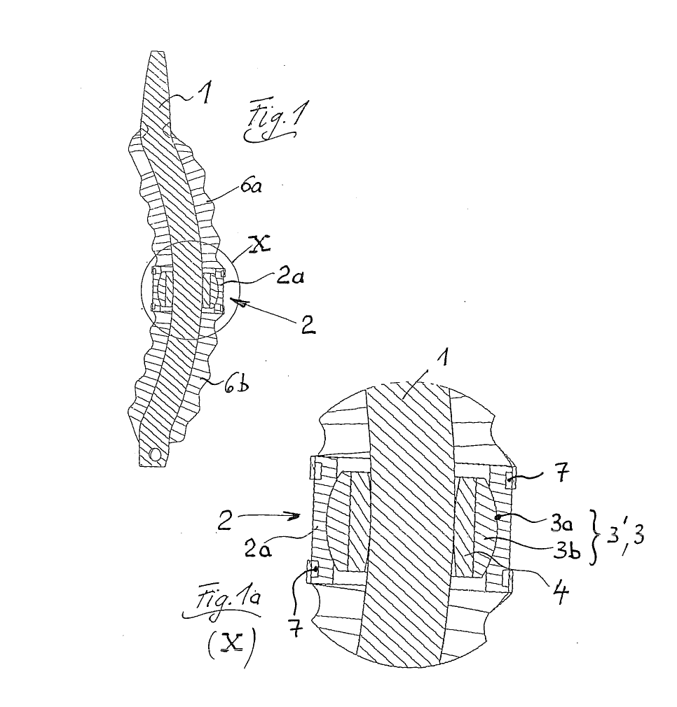

Referring to the drawings in particular, first, with reference to FIG. 1, reference number 1 designates a so-called guideway element, on which a so-called guide element 2 is guided longitudinally displaceably. These two elements 1, 2 are part of a wheel suspension of a motor vehicle, the guideway element 1 being fastened, in a manner not shown, to the vehicle body, while the guide element 2 is connected, likewise in a manner not shown, to a wheel of the vehicle. As is usual, the vehicle body is, of course, supported on the wheel via a spring-absorber arrangement. The exact form of the relative motions between the vehicle body and the wheel, which take place, as is usual, essentially in the vertical direction, is consequently determined, among other things, by the unit comprising the guideway element 1 and the guide element 2, the guideway element 1 being bent at least slightly, i.e., the guideway predetermined by this guideway element 1 extends in a three-dimensionally bent shape.

The guide element 2 has a housing 2a, within which a joint arrangement 3 is provided in the exemplary embodiment according to FIG. 1, here in the form of a ball and socket joint 3′, which is formed by a ball shell 3a, which is incorporated in the housing 2a and in which a so-called ball layer hollow body 3b, analogous to a joint ball of a ball and socket joint, is mounted rotatably. A package of plain bearing rings 4, which are stacked one on top of another and which are plugged with their circular passage openings 4d (cf. FIG. 2) into the guideway element 1 and are guided with their corresponding inner sections by the guideway element 1, is arranged in this ball layer hollow body 3b.

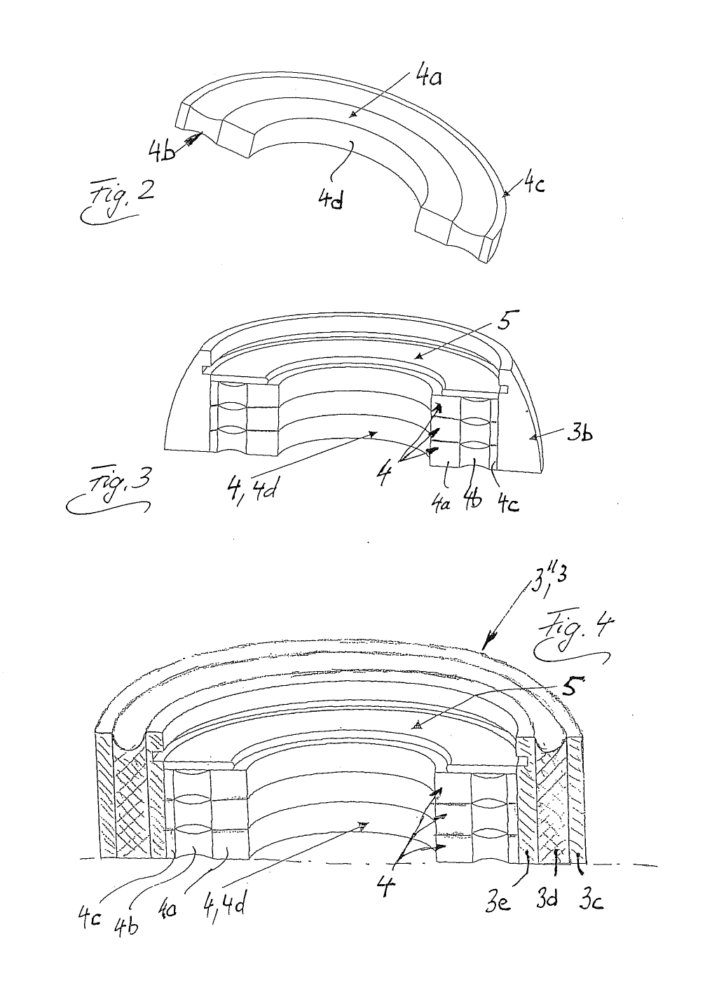

The design of such a plain bearing ring 4 appears from FIG. 2. The so-called inner section is formed by a plastic sliding ring 4a, whose inner edge is in contact with the guideway element 1. With the outer edge. this plastic sliding ring 4a is vulcanized to the inner edge of an elastomer ring 4b, whose outer edge is vulcanized to a metal bushing 4c. The plain bearing ring 4 is fixed with the metal bushing 4c in the ball layer hollow body 3b or in a central cylindrical recess thereof, as is apparent from FIG. 3, in which a section of this ball layer hollow body 3b is shown in a cut-away view. Furthermore, it can be seen here that a plurality of plain bearing rings 4 are stacked one on top of another, and this stack is closed by a securing cover 5 both upwardly (as is shown) and downwardly (not shown). The meaning and purpose of the design of this plain bearing ring 4 were described in detail farther above, and it shall be reiterated here that the elastomer rings 4b shall primarily ensure a slight mobility of the individual plastic sliding rings 4a in the direction at right angles to the longitudinal axis of the guideway element 1.

FIG. 4 shows, instead of a ball and socket joint 3′, a joint arrangement 3 in the form of a rubber bushing 3″, which can also be called an elastomer joint 3″. This rubber bushing 3″ or this joint arrangement 3 in the form of an elastomer joint 3″ comprises a hollow cylindrical outer sleeve 3c, concentrically within which an inner sleeve 3e is connected via the intermediary of an elastomer layer 3d. Analogously to the ball layer hollow body 3b according to FIG. 3, plain bearing rings 4, which are stacked one on top of another and which comprise each a plastic sliding ring 4a, an elastomer ring 4b as well as a so-called metal bushing 4c, are arranged within this hollow cylindrical inner sleeve 3e with an upper securing cover 5 (as well as with a lower securing cover 5, not shown).

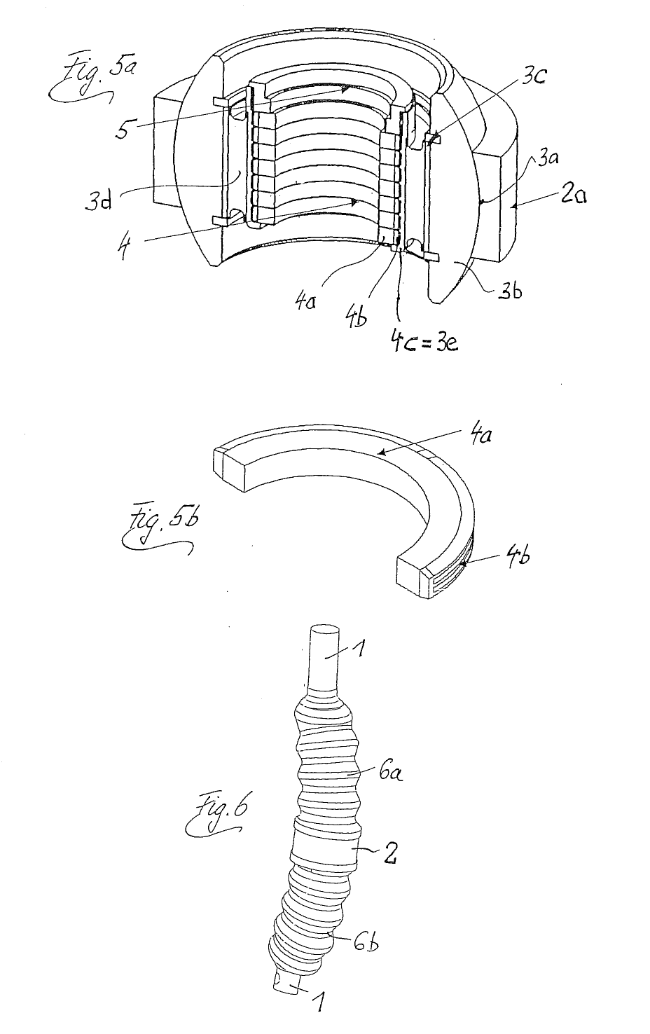

FIG. 5a shows a combination of a ball and socket joint 3′ and an elastomer joint 3″, where the outer sleeve 3c of the elastomer joint 3″ is mounted in a ball layer hollow body 3b as a part of a ball and socket joint 3′. Unlike in the embodiment according to FIGS. 2, 3, the so-called metal bushing 4c of the plain bearing rings 4 stacked one on top of another assumes at the same time the function of the inner sleeve 3e of the elastomer joint 3″ or of the rubber bushing 3″ as a one-piece component (for all plain bearing rings 4), which is an advantage especially in regard to the space needed for installation. According to FIG. 5b, the individual plain bearing ring 4 thus has a metal bushing 4c of its own.

FIG. 1 shows, furthermore, a two-part bellows 6 with the upper part 6a and the lower part 6b, which covers or cover the unit comprising the guideway element 1 and the guide element 2 towards the outside. With their ends facing the guide element 2, the parts 6a and 6b of the bellows 6 are fastened in clamping grooves 7 on the guide element 2 and are fastened in a comparable manner to the guideway element 1 with the other ends (cf. FIG. 6).

The plain bearing solution being proposed for mounting a guide element 2 on a guideway element 1 in a wheel suspension of a motor vehicle makes it possible to form a three-dimensionally curved guideway, as this is necessary especially for wheel suspensions. Moreover, there are advantages over likewise possible roller bearing solutions in terms of costs, weight and requirements on the surface finish and dimensional stability of the guideway, and it shall also be pointed out that a plurality of details can definitely be designed differently from the above explanations without going beyond the scope of the contents of the patent claims.

While specific embodiments of the invention have been shown and described in detail to illustrate the application of the principles of the invention, it will be understood that the invention may be embodied otherwise without departing from such principles.

1-10. (canceled)

11. A guide arrangement and guideway in a wheel suspension of a vehicle with a vehicle body and a wheel, the guide and guideway comprising:
a guideway element;
a guide element, one of said guideway element and said guide element being arranged essentially rigidly connected to the vehicle body and the other of said guideway element and said guide element being arranged essentially rigidly connected to the wheel;
a plain bearing ring with a passage opening formed between said guideway element and said guide element; and
a joint arrangement for arranging said guide element in a rotatingly movable and/or pivotingly movable manner on said guideway element via said plain bearing, said plain bearing ring for a displacing motion of the guide element on the guideway element, said plain bearing ring being arranged within said joint arrangement, said plain bearing ring being guided on the guideway element with said guideway element in said passage opening.

12. A guide arrangement and guideway in accordance with claim 11, wherein said joint arrangement comprises a rubber bushing.

13. A guide arrangement and guideway in accordance with claim 11, wherein said joint arrangement comprises a ball and socket joint.

14. A guide arrangement and guideway in accordance with claim 11, wherein said joint arrangement comprises one of a rubber bushing, with said plain bearing mounted within an inner sleeve of said rubber bushing, and a ball and socket joint with said plain bearing mounted within a hollow body ball of said ball and socket joint.

15. A guide arrangement and guideway in accordance with claim 11, wherein said passage opening is adapted to an annular cross section of said guideway element.

16. A guide arrangement and guideway in accordance with claim 11, further comprising additional plain bearing rings, said additional plain bearing rings and said plain bearing ring providing a plurality of plain bearing rings arranged one on top of another and each provided with a section facing said guideway element, essentially at a right angle to a longitudinal axis of the guideway element, and movable in a hollow body ball or in an inner sleeve of said joint arrangement.

17. A guide arrangement and guideway in accordance with claim 11, wherein said plain bearing ring comprises an elastomer ring, a plastic sliding ring and a metal bushing in contact with said elastomer ring on an outside thereof, said plastic sliding ring being in contact with said elastomer ring on an inside thereof and being vulcanized on said inside.

18. A guide arrangement and guideway in accordance with claim 17, wherein said inside of the plastic sliding ring is rounded.

19. A guide arrangement and guideway in accordance with claim 11, further comprising: a bellows arranged at said guide element and extending essentially along said guideway element, said bellows defining a space between said guide element and the guideway element with said bellows covering over an entire possible path of motion of said guide element on said guideway element against contamination.

20. A guide arrangement and guideway in accordance with claim 19, wherein said bellows has a split design with a bellows part provided to one side of said guide element and a bellows part provided below said guide element.

21. A guide arrangement and guideway in accordance with claim 13, wherein said ball and socket joint includes a rubber bushing.

22. A vehicle wheel suspension guide arrangement and guideway, the vehicle including a vehicle body and a wheel, the vehicle wheel suspension guide arrangement and guideway comprising:
a guideway element;
a guide arrangement comprising a guide element, a plain bearing ring with a passage opening and a joint arrangement, one of said guideway element and said guide element being connected to the vehicle body and the other of said guideway element and said guide element being connected to the wheel, said plain bearing ring for allowing a displacing motion of said guide element on said guideway element, said joint arrangement being defined within said guide element for arranging said guide element in a rotatingly movable and/or pivotingly movable manner on said guideway element via said plain bearing ring, said plain bearing ring being arranged within said joint arrangement, said plain bearing ring being guided on said guideway element with said guideway element in said passage opening.

23. A vehicle wheel suspension guide arrangement and guideway in accordance with claim 22, wherein said joint arrangement comprises one of a rubber bushing and a ball and socket joint and said plain bearing is mounted within a hollow body ball of said ball and socket joint and within an inner sleeve of said rubber bushing.

24. A vehicle wheel suspension guide arrangement and guideway in accordance with claim 23, wherein said passage opening has a cylindrical interior shape adapted to a cylindrical shape of said guideway element.

25. A vehicle wheel suspension guide arrangement and guideway in accordance with claim 24, further comprising additional plain bearing rings, said additional plain bearing rings and said plain bearing ring providing a plurality of plain bearing rings arranged one on top of another with each of said plurality of plain bearing rings provided with a section facing said guideway element essentially at a right angle to a longitudinal axis of the guideway element, said plurality of plain bearing rings being movable in said hollow body ball or in said inner sleeve of said joint arrangement.

26. A vehicle wheel suspension guide arrangement and guideway in accordance with claim 22, wherein said plain bearing ring comprises an elastomer ring, a plastic sliding ring and a metal bushing in contact with said elastomer ring on an outside thereof, said plastic sliding ring being in contact with said elastomer ring on an inside thereof and being vulcanized on said inside.

27. A vehicle wheel suspension guide arrangement and guideway in accordance with claim 26, wherein said inside of the plastic sliding ring is rounded.

28. A vehicle wheel suspension guide arrangement and guideway in accordance with claim 23, further comprising: a bellows arranged at said guide element and extending essentially along said guideway element, said bellows defining a space between said guide element and the guideway element that is covered over an entire possible path of motion of said guide element on said guideway element against contamination.

29. A vehicle wheel suspension guide arrangement and guideway in accordance with claim 28, wherein said bellows has a split design with a bellows part provided to one side of said guide element and a bellows par provided below said guide element.

30. A vehicle wheel suspension guide arrangement and guideway in accordance with claim 23, wherein said ball and socket joint includes a rubber bushing.
